(19) United States
(12) Patent Application Publication
(10) Pub. No.: US 2022/0074596 A1
(43) Pub. Date: Mar. 10, 2022

(54) MULTI PLANAR HEATER ELEMENT FOR USE IN A HIGH-SPEED OVEN INCORPORATING A NOVEL TENSIONING SYSTEM

(71) Applicants: DE LUCA OVEN TECHNOLOGIES, LLC, San Francisco, CA (US); TAYLOR COMMERCIAL FOODSERVICE, LLC, Rockton, IL (US)

(72) Inventors: Nicholas P. DE LUCA, San Francisco, CA (US); Andrew PERKINS, San Francisco, CA (US); James J. MINARD, Rockton, IL (US); Nathan MATZ, Rockton, IL (US)

(21) Appl. No.: 17/419,852

(22) PCT Filed: Feb. 6, 2020
(86) PCT No.: PCT/US2020/016972

§ 371 Date: Jun. 30, 2021

Related U.S. Application Data
(60) Provisional application No. 62/801,750, filed on Feb. 6, 2019.

(51) Int. Cl. F24C 7/06; F24C 7/04; H05B 3/06; H05B 3/24; H05B 1/02; F24C 7/08

(52) U.S. Cl. CPC F24C 7/067; F24C 7/046; H05B 3/06; H05B 2203/032; H05B 1/0263; F24C 7/087; H05B 3/24

(57) ABSTRACT

This disclosure relates to a multi-planar heater element for use in a high-speed oven with a new tensioning system. Disclosed subject matter includes a radiative heater for use in a high-speed oven formed from two or more planar heater elements stacked closely to form an effective single element and allowing for extended life through the minimization of concentrated eddy currents in both elements. The disclosure further includes structures to install and remove various planar heating elements without any external tools.

### CROSS-REFERENCE TO RELATED APPLICATIONS

This application claims priority from U.S. Provisional Application No. 62/801,750, filed on Feb. 6, 2019, the entirety of which is fully incorporated by reference herein.

### FIELD

The present disclosure teaches a radiative heater for use in a high-speed oven formed from two or more planar heater elements stacked closely to form an effective single element and allowing for extended life through the minimization of concentrated eddy currents in both elements. Compared to a single planar element, the multi-planar heater element creates a modified magnetic field that helps to diffuse the current evenly and minimizes any concentrated currents that greatly reduce the usable life of the element by creating current concentrations resulting in local heat spots or pockets.

The invention enabling the use of an etched or stamped metal plate or ribbon as further described in co-pending U.S. provisional patent application No. 62/730,893 filed Sep. 13, 2018, later filed as PCT/US2019/050805 on Sep. 12, 2019 entitled “Heater Element Incorporating Primary Conductor for Use in a High-Speed Oven” (“the '805 PCT application”), the entirety of which is incorporated by reference herein, to operate at high power levels at a significant increase in life (observed at 3 to 75 times). The element may be formed from a single material stock or mesh with two more sections of different thickness and density adjusted to optimally deliver heat to an item to be cooked. The heater element is suitable for use at low voltages with a De Luca Element ratio of less than 2 (when compared to a 0.25 m×0.25 m flat area and with a resistance measured across the oven length) and further allowing for heat ramp up to a maximum temperature in less than 3 seconds. In some embodiments, the heater element includes ends with a lower electrical resistance to allow connectivity of elements in series and further insure that the ends do not over heat as well as to facilitate the proper clamping and tensioning of the element.

The invention further incorporating a novel tensioning and clamping method for the heater element. The tensioning and clamping mechanism enabling a quick change during use as well as proper registration during placement and alignment during use.

### BACKGROUND

The use of heater mesh is fully described by De Luca in U.S. Pat. No. 8,498,526B2 as a means to safely deliver high power at a low voltage to an oven cavity. Typical means described by De Luca for delivering a high power output at a wavelength of 1-3 microns (which is most ideal for cooking food items such as toast) involves use of an element which when forming an oven of 0.25 m×0.25 m with a top and bottom element in parallel has the typical characteristic of having a ratio of its resistance to a black body radiative surface area of less than 2 ohms/m2. As further described by De Luca in U.S. Pat. No. 8,498,526B2 the ability to quickly increase the temperature of the element is important to facilitate high speed cooking, avoid energy consumption when the oven is not in use, allow for “instant” use, and further to be able to cycle the heater on and off so as to prevent excessive heating. The ability to cycle the heater is required for the process of being able to cook with a high power radiative heater and a recipe for an item can typically include 3-15 on-off cycles.

The co-pending '805 PCT application describes a heater formed from a single planar sheet of metal and includes a step used to decrease the thickness of the metal in the heater area and thus increase the speed at which the element heats. The element can be formed with holes in a mesh pattern so as to increase the black body radiative area and also increase the resistance of the metal. While the use of a flat sheet mesh versus a wire mesh has significant manufacturing advantages at high power levels with significant cycling (i.e., generally greater than 30 watts per square inch of flat cooking surface and greater than 1000 on-off cycles), it has been observed that the heater elements have a usable life of less than 1000-5000 cycles before failure. In comparison, round wire mesh operated at similar power levels may have an operational life of 10-15,000 cycles.

Life expectancy data for heater materials typically operate in a constant on mode and the primary deterioration is associated with oxidation of the element when hot. As an example, planar mesh formed per the '805 PCT application may have a life of far greater than 100,000 seconds when left on at 2500 watts but when cycled on for 5 seconds, off for 5 seconds at the same wattage, the element will only last 5-15,000 seconds. As an example, the following chart shows the results of 3 different tests of a single layer 5″×8.25″ planar heating element NP25 operated in two power regimes 2000 W and 1500 W. The planar heating element NP25 lasted a total of 8220 seconds on when cycled 5 seconds on 5 seconds off versus 100,000+ seconds on when cycled only 28 times during a continuous test at two different power levels.

| Example 1 | Cycles | Seconds On | Voltage | Power |
|---|---|---|---|---|
| NP25-K | 1644 | 8220 | 25.60 | 2112 |
| NP25-K | 28 | 100800+ | 25.60 | 2099 |
| NP25-K | 28 | 100800+ | 20.8 | 1352 |

Similarly, in example 2, the planar heating element NP-16 measuring 5″×8.25″ lasted a total of 11,000 seconds on when cycled on and off every 5 seconds but continued past 100,000 seconds when cycled only 28 times during a continuous test.

| Example 2 | Cycles | Seconds On | Voltage | Power |
|---|---|---|---|---|
| NP16-304 | 2200 | 11000 | 20.8 | 3120 |
| NP-16-304 | 28 | 100800 | 20.8 | 2870 |

In examples 1 and 2 above, the materials used respectively were a Kanthal (an iron based material) and a 304 stainless. In both cases it was clear that the cycling of the element was responsible for the early failure versus a result of the material itself.

One obvious solution to the above limitation on life through cycling would be to operate at a lower voltage value and pass less electrical current through the element. Typical life curves for material operating in the radiative regime of 800-1400 degrees C. decrease exponentially as the temperature and associated power increase. In the case of using a high speed oven though, this is not a solution as temperature ramp up needed of the element is typically 100-500 degrees C. per second, and thus is not an option as 15000-5000 W is typically needed for an 8.5×5″ planar element.

Another obvious option for increasing the life of the planar element involves modifying the tensioning system to reduce tension. Crack propagation in materials is associated with the stress in the material and therefore it would seem logical that an increase in stress would accelerate potential crack propagation and failure. While reducing the spring force has some effect, example 3 below clearly shows that even a 10× reduction in the tension only increases life by about 50% in the planar element.

Example 3

| | Life Cycles | Power | Spring | | Voltage |
|---|---|---|---|---|---|
| NP26-K | 1000 | 2558 | 19 | lbs/in | 20.8 |
| NP26-K | 1527 | 2374 | 2 × 1.67 | lbs/in | 22.4 |

In further considering the tremendous life discrepancy associated with a constant on mode versus cycling, another obvious observation could be made regarding the propagation of cracks with the cooling and heating of the element. It could be concluded that by keeping the average temperature over the test more consistently high, the material would undergo less elongation change during the test and therefore the life would be increased. In example 4, the cycling of the 5 seconds on 5 seconds off test was changed to 5 seconds on, 2 seconds off in hopes of seeing an improvement in the performance No such improvement was seen.

| Example 4 | Life Cycles | Power | Cycle | Voltage |
|---|---|---|---|---|
| NP24-K | 2400 | 2612 | 5 secON 5 secOFF | 28.7 |
| NP24-K | 1684 | 2622 | 5 secON 2 secOFF | 28.5 |

As described in co-pending the '805 PCT application (which designates the US), the compact U shape element formed from a single planar metal allows for tensioning from a non-current applying side and power delivery from fixed ends. During use though, concentrated heat patterns are observed to develop at the union end between the legs of the “U” as the current wraps around from one terminal to another and failure occurs at the juncture of the union end and the mesh. These concentrations of heat are observed as glowing hot spots on the union section metal and they tend to increase in size and depth with the number of cycles the mesh is operated. Specifically, within said application, FIGS. 3, 4, 9, and 10 show a “U” element with the union end and indications of the overheated area. Further, the formation of connections within the union area of the “U” element with equivalent resistance paths is described which has been shown to help decrease the concentration of power and heat within the union. Though this tends to decrease the formation of hot spots within the union, the extension in life provided appears to be only minimally significant as compared to achieving the same life of a wire mesh of 10,000 cycles. As shown in example 5, accounting for power decrease, only a minimal increase, if any, was achieved through the application of even pathways at the union end.

| Example 5 | Life Cycles | Power | Union Description | Voltage |
|---|---|---|---|---|
| NP18-304 | 2200 | 2870 | Solid Back | 20.8 |
| NP24-304 | 3655 | 2184 | Modified Union Path | 20.8 |
| NP25-304 | 2883 | 1789 | Modified Union Path | 20.8 |

When using the above mentioned preferred “U” element design, the failure mode of the element appears as an overheating of a single filament at the juncture of the long segments and the union. When a single filament along the current path fails, a cascade effect occurs as the electrical current is concentrated in fewer and fewer of the strands until the element no longer operates. Attempting to cool this area using a tube to blow air would be an obvious option, yet doing so provided minimal or no increase in life as shown in Example 6.

| Example 6 | Life Cycles | Power | Union Description | Voltage |
|---|---|---|---|---|
| NP17-304 | 1500 | 3328 | No Cooling | 20.8 |
| NP17-304 | 1496 | 3328 | Air Cooled | 20.8 |
| NP17-304 | 1519 | 3328 | Air Cooled | 20.8 |

Another and final obvious construction to try to increase the life of a planar heating element used in cycling applications such as a “U” element, would be to increase the thickness of the element and further avoid the use of a step which may cause a stress concentration. While increasing the thickness of the element will inherently increase the elements mass and therefore the time required to heat up, it could be presumed that doing so would also increase the strength of the element and reduce the potential for crack propagation due to cycling. In example 7, several elements are compared including two made of a single thickness of 0.015″ Kanthal A1 and one made of a 0.004″ thick Kanthal D. Despite the variance associated with tensioning force and power levels, there is little to no increase in the life of the element compared to other planar elements for the thicker elements despite their being made of Kanthal A1 (a higher grade material for use in this application).

| Example 7 | Life Cycles | Power | Description | Voltage |
|---|---|---|---|---|
| NP26-K | 1000 | 2558.4 | 0.015″ Thick | 20.8 |
| | | | 19 lb/in spring | |
| NP26-K | 1527 | 2374.4 | 0.015″ Thick | 22.4 |
| | | | 2 × 1.67 lbs/in | |
| NP04-K U | 4118 | 2764.5 | 0.004″ Thick | 28.5 |
| | | | Gravity < .5 lbs | |

While there has been some increase in life associated with applying no tensioning with the exception of gravity to the element (NP04-K above achieved a life of about 4118 cycles) and in some cases not using a “U” but instead applying the voltage across the entire width as a single element evenly (in this case a straight NP04-K achieved 6000 cycles before partial degradation), no tests using flat sheet have shown the same life as a wire mesh.

Prior to the herein described invention, the following plot shows cycle life for various flat heating elements produced per the '805 PCT application, or U.S. Pat. No. 8,498,526B2 “Wire Mesh Thermal Radiative and Use in a Radiative Oven”. All elements are approximately 5″×8.25″ in size and vary in geometric mesh cut patterns to adjust for the appropriate voltage and current.

In addition, the following table lists details of the testing for these various elements as well as their corresponding DER per U.S. Pat. No. 8,498,526B2.

| | | | | | | Single | |
|---|---|---|---|---|---|---|---|
| | | Max | | Single | Single | Element | Extrapolated Element |
| | | Life | | Element | Element | Radiative | Radiative Area for |
| PART# | Description | Cycles | Voltage | Resistance | Watts | Area | 0.25 m × 0.25 [symbol] oven |
| NP04-K | [symbol] D 30% Open | 4313 | 28.50 | 0.29 | 2769 | 0.04 | [symbol] |
| | Diagonal Diamond [symbol] | | | | | | |
| NP04-K | Straight 5 [symbol] × | [symbol] | [symbol] | 0.08 | [symbol] | 0.04 | [symbol] |
| | 8.37 [symbol] 30% | | | | | | |
| 18x18.012 | [symbol] A1 Wire Mesh | 11443 | 13.73 | [symbol] | [symbol] | 0.04 | [symbol] |
| | 18 × 18 0.012 [symbol] | | | | | | |
| NP15-304 | Large Diamond 50% | 900 | 20.80 | 0.14 | [symbol] | 0.08 | [symbol] |
| NP15-304 | Large Diamond 50% | 1700 | 20.80 | 0.16 | [symbol] | 0.08 | [symbol] |
| NP15-304 | Large Diamond 50% | [symbol] | 20.80 | 0.15 | 2891 | 0.08 | [symbol] |
| NP15-K | Large Diamond 50% | 2200 | 20.80 | 0.15 | 2891 | 0.03 | [symbol] |
| NP16-304 | Small Diamond 50% | 2200 | 20.80 | 0.14 | 3120 | 0.03 | [symbol] |
| NP16-304 | Small Diamond 50% | [symbol] | 20.80 | [symbol] | [symbol] | 0.03 | [symbol] |
| NP16-304 | Small Diamond 50% | [symbol] | 20.80 | [symbol] | [symbol] | 0.03 | [symbol] |
| NP17-304 | Large Square 50% | 1300 | 20.80 | 0.14 | 3162 | 0.03 | [symbol] |
| NP17-304 | Large Square 50% | [symbol] | 20.80 | 0.13 | [symbol] | 0.03 | [symbol] |
| NP17-304 | Large Square 30% | 2254 | 20.80 | 0.13 | [symbol] | 0.08 | [symbol] |
| NP17-304 | Large Square 30% | 1496 | 20.80 | 0.13 | [symbol] | 0.08 | [symbol] |
| NP17-304 | Large Square 30% | [symbol] | 20.80 | 0.13 | [symbol] | 0.08 | [symbol] |
| NP18-304 | Small Square 30% | 4200 | 20.80 | 0.15 | [symbol] | 0.08 | [symbol] |
| NP18-304 | Small Square 30% | 2200 | 20.80 | 0.15 | 2870 | 0.08 | [symbol] |
| NP18-304 | Small Square 30% | 814 | 20.80 | 0.15 | [symbol] | 0.08 | [symbol] |
| [symbol] | Small Square Even | [symbol] | 20.80 | 0.20 | [symbol] | 0.08 | [symbol] |
| | Path Filled Back 50% | | | | | | |
| [symbol] | Small Square Even | 2400 | 20.80 | 0.32 | 2612 | 0.08 | [symbol] |
| | Path Filled Back 50% | | | | | | |
| [symbol] | Small Square Even | 975 | 20.80 | 0.20 | 3112 | 0.08 | [symbol] |
| | Path Filled Back 50% | | | | | | |
| [symbol] | Small Square Even | 2050 | 20.80 | 0.31 | [symbol] | 0.03 | [symbol] |
| | Path Filled Back 30% | | | | | | |
| [symbol] | Small Square Even | 1684 | 20.80 | 0.31 | [symbol] | 0.03 | [symbol] |
| | Path Filled Back 30% | | | | | | |
| [symbol] | Small Square Even [symbol] | 1644 | 25.50 | 0.24 | [symbol] | 0.03 | [symbol] |
| [symbol] | Small Square Even [symbol] | [symbol] | 20.80 | 0.24 | [symbol] | 0.03 | [symbol] |
| [symbol] | Small Square Even [symbol] | [symbol] | 20.80 | 0.32 | [symbol] | 0.03 | [symbol] |
| NP25-K | Small Square Even [symbol] | [symbol] | 20.80 | 0.31 | [symbol] | 0.03 | [symbol] |
| NP25-K | Small Square Even [symbol] | 28 | 25.50 | 0.31 | [symbol] | 0.08 | [symbol] |
| NP25-K | Small Square Even [symbol] | 28 | 28.70 | 0.17 | [symbol] | 0.08 | [symbol] |
| NP26-K | Small Square Triangle | 1000 | 20.80 | 0.21 | [symbol] | 0.08 | [symbol] |
| | Back 0.015 [symbol] thick 30% | | | | | | |
| NP26-K | Small Square Triangle | [symbol] | 21.40 | [symbol] | 2374 | 0.08 | [symbol] |
| | Back 0.015 [symbol] thick 30% | | | | | | |

| | Extrapolated Element | | Extrapolated | |
|---|---|---|---|---|
| | Resistance for | | Power/DER | |
| PART# | 0.25 m × 0.25 m oven | DER | Ratio | Notes |
| NP04-K | 0.04 | 0.25 | 44.872 | |
| NP04-K | 0.01 | 0.07 | [symbol] | |
| 18x18.012 | 0.01 | 0.05 | [symbol] | |
| NP15-304 | 0.02 | [symbol] | [symbol] | |
| NP15-304 | 0.02 | 0.18 | [symbol] | |
| NP15-304 | 0.02 | 0.18 | [symbol] | |
| NP15-K | 0.02 | [symbol] | [symbol] | |
| NP16-304 | 0.02 | [symbol] | [symbol] | |
| NP16-304 | 0.02 | [symbol] | [symbol] | [symbol] |
| NP16-304 | 0.02 | 0.15 | [symbol] | Modified Union to increase Bus |
| NP17-304 | 0.02 | 0.15 | [symbol] | [symbol] |
| NP17-304 | 0.02 | 0.15 | 87,205 | |
| NP17-304 | 0.02 | 0.15 | 87,205 | Modified Union to increase Bus |
| NP17-304 | 0.02 | 0.15 | 87,205 | Cooled |
| NP17-304 | 0.02 | 0.15 | 87,205 | Cooled |
| NP18-304 | 0.02 | 0.17 | [symbol] | [symbol] |
| NP18-304 | 0.02 | 0.18 | [symbol] | |
| NP18-304 | 0.02 | 0.17 | [symbol] | 5 sec on 15 sec off |
| [symbol] | 0.02 | 0.23 | [symbol] | |
| [symbol] | 0.02 | 0.27 | [symbol] | |
| [symbol] | 0.02 | 0.23 | [symbol] | Modified Union |
| [symbol] | 0.04 | 0.38 | [symbol] | Modified Union |
| [symbol] | 0.04 | 0.38 | [symbol] | 5 sec on 2 sec off |
| [symbol] | 0.04 | 0.38 | [symbol] | |
| [symbol] | 0.03 | [symbol] | [symbol] | |
| [symbol] | 0.03 | [symbol] | [symbol] | |
| NP25-K | 0.04 | 0.38 | [symbol] | [symbol] |
| NP25-K | 0.04 | 0.37 | [symbol] | [symbol] |
| NP25-K | 0.04 | 0.37 | [symbol] | [symbol] |
| NP26-K | 0.02 | 0.20 | [symbol] | 19 [symbol] |
| NP26-K | 0.0 [symbol] | 0.25 | [symbol] | 1.67 [symbol] |

[symbol]

indicates data missing or illegible when filed

It is important to note that the DER values which represent the ability of the element to quickly get hot and radiate power are all well below a threshold value of 2.

It is also important to consider the magnetic fields produced as a result of the high current in the element and the induced electrical currents as the heater is switched. An electric current passing through a wire can be characterized by amperes law:

B=I_{x μ0}/2πr

Where, B is the magnetic field in Tesla produced by the current I, at a distance r, and with the permeability of free space equal to:

μ₀=4π×10⁻⁷ Tm/A

As an example, a wire carrying 110 amps would produce a magnetic field of 2.2 gauss at approximately 0.1 meters. In addition, the magnetic field created when a current is pulsed on or off creates a greater magnetic field that is described by Faraday's law which states that the induced current is proportional to the rate of change of the magnetic field. When using a single layer element, the induced current and magnetic fields produced can force the current to flow in specific areas that therefore concentrate heat and lead to deterioration of the element. Magnetic fields in the range of 0-40 gauss have been measured on single layer elements further described above in non-shielded areas.

Placing a planar heating element within a heating cavity and insuring that the heater is properly connected to the electrical and tensioning system can be difficult. Replacing the element quickly is necessary within the context of use within a quick serve or drive through restaurant. In some cases the element may not latch correctly and may slip off during the normal expansion and contraction that occurs during use. In addition, if proper force in not applied at the electrical connection ends, the high electrical current may arc and increase the temperature at the connection which eventually leads to oxidation and thermal degradation including melting.

It is therefore a primary objective of the following invention to provide for a planar heater element that can be used in a high speed oven and can operate at over 1500 watts and can be cycled on and off at a 5 sec on 5 sec off rate with a life of greater than 15,000 cycles.

It is further an objective of the following invention that the heater element described above could be made per the description of co-pending the '805 PCT application (which designates the US) and as such does not require a separate welding step for manufacturing.

It is another objective of the current invention that the heating element be useful in a safe high speed oven and be operational at a low voltage of 0-48V and have a have a low electrical resistance of less than 2 ohms so as to deliver at least 1500 W for a 5″×8.5″ sized element.

It is another objective of the current invention that the heating element be able to achieve a ramp up heating rate of at least 100 degrees C. per second.

It is another objective of the following invention to provide for a heater element that has a DER of less than 2 ohms/m2.

It is a further objective of the following invention that the heater element provided be easy to register and to place within the oven or holder and that it is properly tensioned during use.

### SUMMARY

The present teachings provide embodiments of a novel bi-planar heater element, and features thereof, which offer various benefits. The invention provides for a bi-planar heater element that can be used in a high speed oven and can operate at over 1500 watts and can be cycled on and off at a 5 sec on 5 sec off rate with a life of greater than 15,000 cycles. One element herein described having been cycled over 74,000 times at 2500 watts. The heater made by overlaying two similar elements and forming a common path for current flow. Each of the elements inducing a magnetic field in the other during operation such that the electrical eddy currents and current concentrations normally present in a single layer are moved more evenly throughout the element and thus increase the life of the element. The element further being capable of being manufactured from a singular piece of sheet metal that could be made per the description of the '805 PCT application (which designates the US) and as such does not require a separate welding step for manufacturing. The high wattage heater further capable of being safely operated within a high speed oven and at a low voltage of 0-48V and have a have a low electrical resistance of less than 2 ohms so as to deliver at least 1500 W for a 5″×8.5″ sized element at low voltage. The element being formed by a material thin enough to be powered and achieve a ramp up heating rate of at least 100 degrees C. per second and to be cycled on and off for optimum cooking recipes. As such, the invention provides for a heater element that has a DER of less than 2 ohms/m2 as further defined by U.S. Pat. No. 8,498,526B2 “Wire Mesh Thermal Radiative and Use in a Radiative Oven”. In some embodiments, the bi-planar heater element has ends that are increased in thickness and density so as to provide more material which acts as a primary conductor as further described in co-pending US patent application “Stepped Heater Element for Use in A High Speed Oven”. In a preferred embodiment, the element is formed using an etching process (such as EDM or chemical etching) that creates two or more distinct thicknesses in the element so as to lower the resistance of the mesh at the integrated primary conductor areas and then folded on itself to create the two heating layers. The manufacturing process further enabling elements to be formed with quasi-identical segments that allows for ease of tensioning and registration within a secondary conductor and use with higher voltage. The manufacturing process also allowing for formation of a roll of elements located end to end such that a continuous element is created from a single original sheet which can be formed into a bi-layer heating element at the time of use. Additional coatings can be applied to the element during the manufacturing process which can be done in a continuous automated fashion.

It is to be understood that both the foregoing general description and the following detailed description are exemplary and explanatory and are intended to provide further explanation of the invention as claimed.

### BRIEF DESCRIPTION OF THE FIGURES

The accompanying drawings, which are included to provide a further understanding of the invention and are incorporated in and constitute a part of this specification, illustrate embodiments of the invention, and together with the description serve to explain the principles of the invention.

FIG. 1 is an isometric view of a flat mesh heating element made from a single flat sheet and foldable so as to create two parallel planar sections for carrying a high current further spaced together so as to induce mutual magnetic fields during use that distribute the current evenly and allow for cycling above 15,000 times.

FIG. 2 is an isometric view of the heating element in FIG. 1 folded so as to create a multi-planar element.

FIG. 3 is an isometric view of the heating element of FIGS. 1 and 2 folded completely to form a multi-planar heating element.

FIG. 4 is an isometric closeup view of the connection paths of the union section of the multi-planar heating element of FIGS. 1, 2, and 3.

FIG. 5 is an isometric view of a tensioning system used to hold the mesh of FIGS. 1-3.

FIG. 5a is a perspective view of a set of holder boxes without elements secured thereto.

FIG. 5b is another perspective view of the holder boxes of FIG. 5a with an element installed thereon, with the user rotating one clamp to allow one side of the element to be removed with the other clamp engaging the other side of the element.

FIG. 5c is a top view of an element for use with the holder box of FIGS. 5a and 5b.

FIG. 5d is a perspective view of a holder box showing the opposite end of the element engaged with a carrier.

FIG. 5e is another perspective view of the holder box of FIG. 5d showing the end of the element bent away from the carrier and the user pressing the carrier away from the side wall of the holder box.

FIG. 5f is another perspective view of the holder box of FIG. 5d with the end of the element not attached to the carrier and the carrier not pressed away from the side wall of the holder box.

FIG. 5g is a detailed perspective view of the carrier that is slidably attached to the holder box of FIG. 5d.

FIG. 5h is a view of detail AA of FIG. 5c.

FIG. 5i is a view of an alternate hole that may be provided upon the element to allow for the element to only be installed upon the frame in one direction and orientation.

FIGS. 6a and 6b are isometric views of a roll of sequentially formed elements such as that in FIG. 1c so as to create a continuous string of elements.

FIG. 7 is an isometric view of the manufacturing process used to make the element of FIGS. 1-6 further including a coating process.

FIG. 8 is a diagram illustrating the relative placement of the multi-planar heating element on a plot of the life during cycling versus the wattage and further compared to past developed heating elements with DER values less than 2 for use in high speed ovens.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DESCRIPTION

The present teachings disclose a novel heating element having a DER of less than 2 ohms/m2 an ability to be powered at over 1500 watts, capable of increasing repeatedly in temperature at a rate of at least 100 degree C. per second, and be capable of being cycled more than 15,000 times on and off every 5 seconds. The following details the specifications of two such bi-layer elements and the cycling life achieved when cycled 5 seconds on/5 seconds off. As can be seen from the table, the first element cycled over 74,378 times before complete failure and the second cycled over 50,000 times.

0.004 K-Diamond Cut 50% Bi Metal W/Cut Even 0.015″ Back

| | | |
|---|---|---|
| Max Life Cycles | 74378 | cycles |
| Voltage | 20.80 | volts |
| Single Element Resistance | 0.17 | ohms |
| Single Element Watts | 2496 | watts |
| Single Element Radiative Area | 0.05 | m2 |
| Extrapolated Element Radiative Area for | 0.21 | m2 |
| 0.25 m × 0.25 m oven | | |
| Extrapolated Resistance Radiative Area | 0.02 | ohm |
| for 0.25 m × 0.25 m oven | | |
| DER | 0.1 | ohm/m2 |
| Extrapolated Power/DER Ratio | 98106 | watts-m2/ohm |

0.004 K-Diamond 50% Bi Metal W/Filled Even 0.015″ Back

| | | |
|---|---|---|
| Max Life Cycles | 50000+ | cycles |
| Voltage | 23.20 | volts |
| Single Element Resistance | 0.19 | ohms |
| Single Element Watts | 2853 | watts |
| Single Element Radiative Area | 0.05 | m2 |
| Extrapolated Element Radiative Area for | 0.21 | m2 |
| 0.25 m × 0.25 m oven | | |
| Extrapolated Resistance Radiative Area | 0.02 | ohm |
| for 0.25 m × 0.25 m oven | | |
| DER | 0.11 | ohm/m2 |
| Extrapolated Power/DER Ratio | 103072 | watts-m2/ohm |

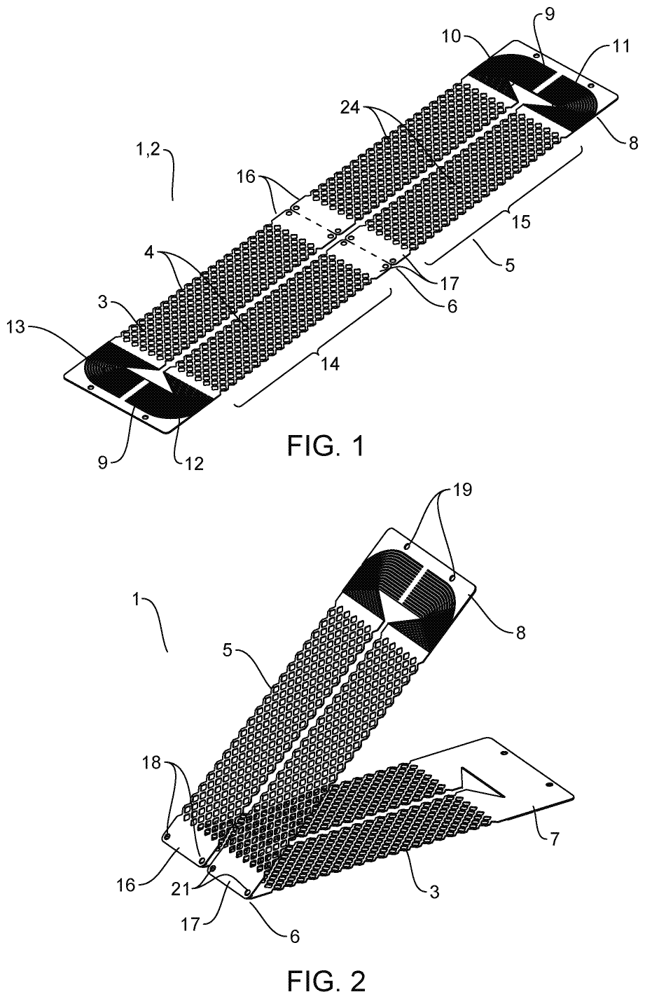

FIG. 1a is an isometric view of the novel heating element 1 in a preferred embodiment formed from a single sheet of heating material 2. These materials include Kanthal alloys, stainless steel alloys, nickel chromium alloys, and other ferrous and non-ferrous metals used for heating elements. Mesh areas 4 and 24 formed through etching, stamping, or other machine process on both halves 3 and 5 along centerline 6 such that the resistance of the element is matched with the driving voltage and current required. In some cases, mesh areas 4 and 24 may be solid, thinned, cut, and otherwise modified. Heating element 1 having a DER of less than 2 ohms/m2 an appropriate resistance which may be less than 2 ohms. Halves 3 and 5 having union ends 7 and 8 respectively and formed with equal resistive paths 9 to mitigate the formation of hot spots during operation in areas 10, 11, 12, and 13. In some cases meshed areas 14 and 15 further thinned down in thickness compared to ends 16 and 17 and union areas 7 and 8 such that the regions can be heated quickly to an optimum wavelength for radiative cooking. As an example, meshed areas 14 and 15 may have a thickness of 0.002″-0.015″ while union ends 16 and 17 may be 0.015″-0.100″ thick.

In FIG. 2, halves 3 and 5 are folded along centerline 6 so as to mate union ends 7 and 8, ends 17 and 18, and meshed areas 4 and 24 as well as the tensioning holes 18, 21, and 19 on half 5 to the corresponding holes on half 3.

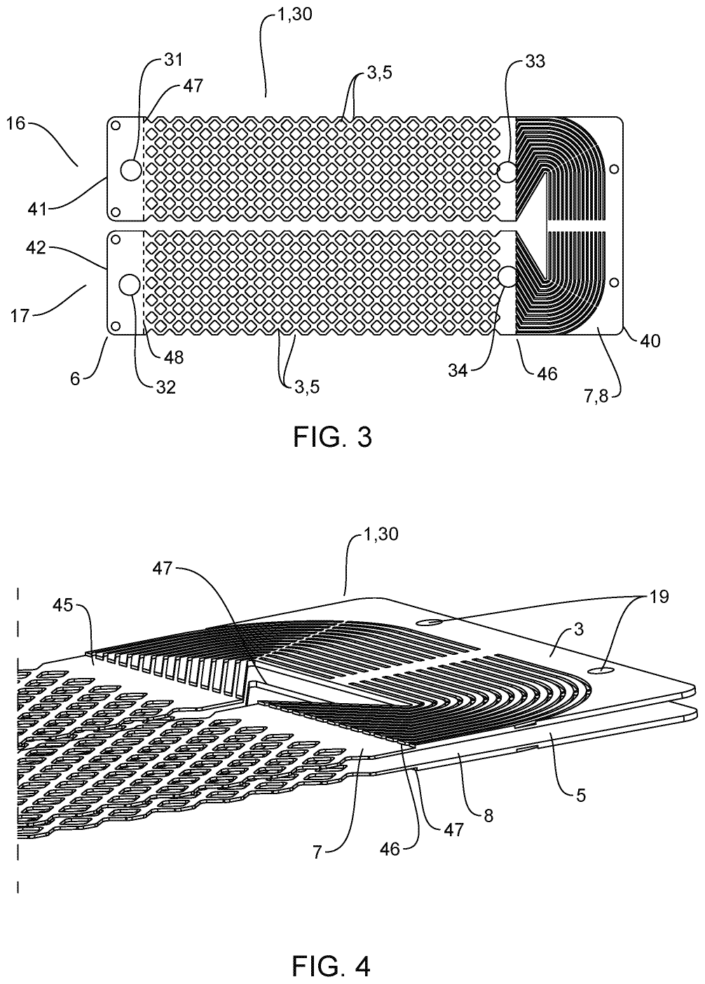

FIG. 3 illustrates element 1 now completely folded at centerline 6 to form element 30 with edges 40, 41, and 42 and mated areas 3 and 5. In some cases, welding the two halves 3 and 5 in regions 31, 32, 33, and/or 34 may help to insure proper current distribution when the element is powered from ends 16 and 17.

In one preferable embodiment, the stepped down at 45, 46, 47, and 48 of FIGS. 3 and 4 allows for a flat surface for mating in region 5 between halves 3 and 5. The closer mating of the surfaces allowing for the induced magnetic fields during operation to affect the current flow to thereby avoid current concentrations.

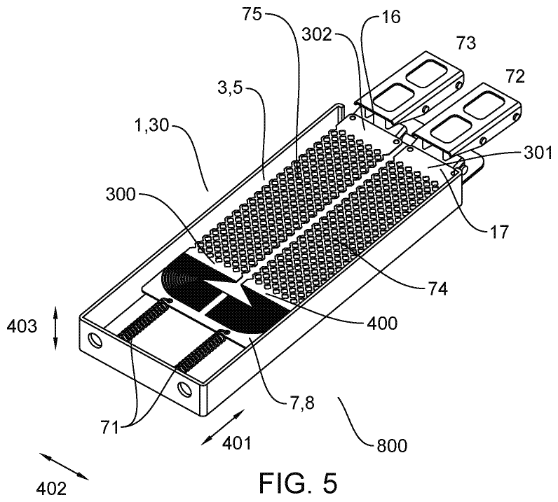

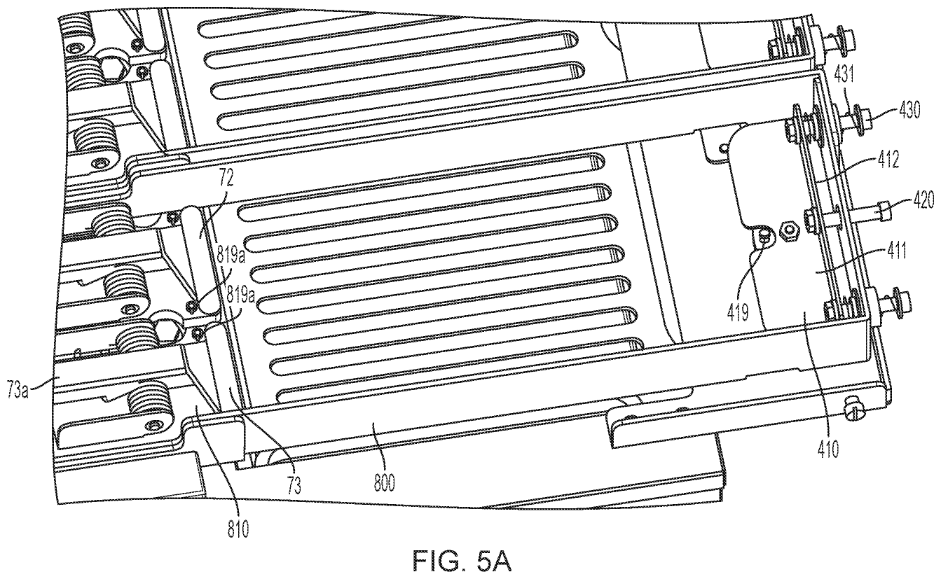

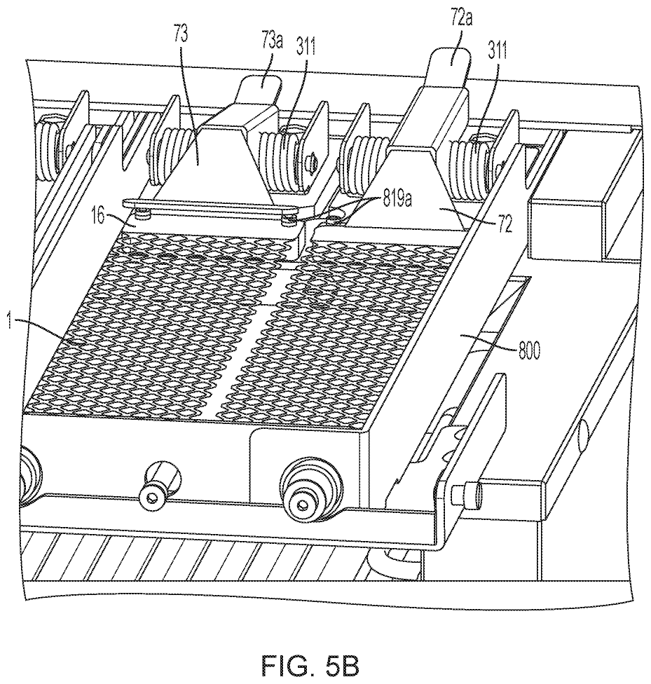

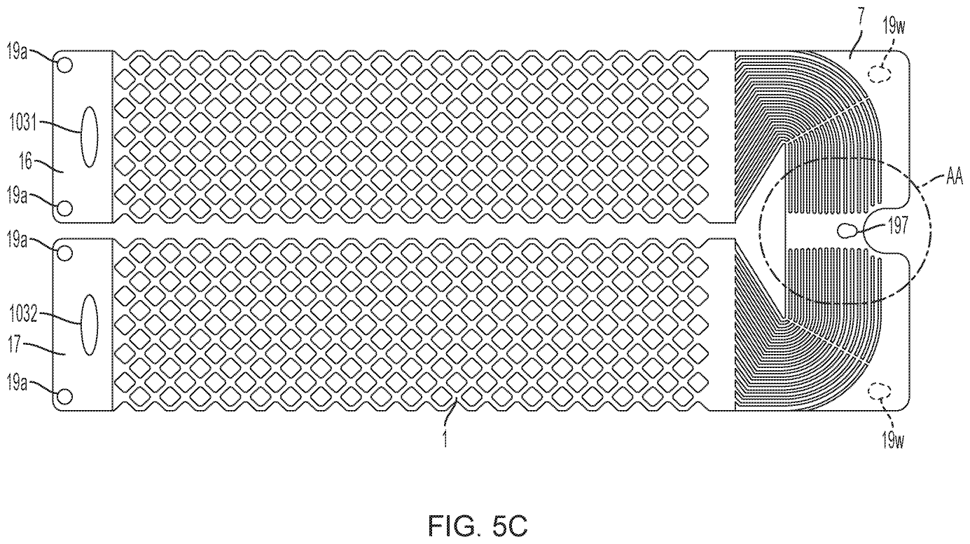

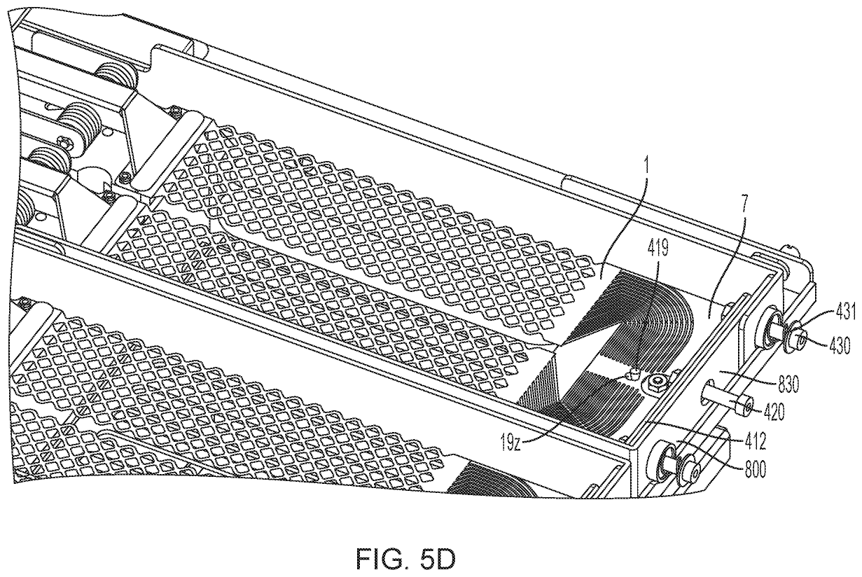

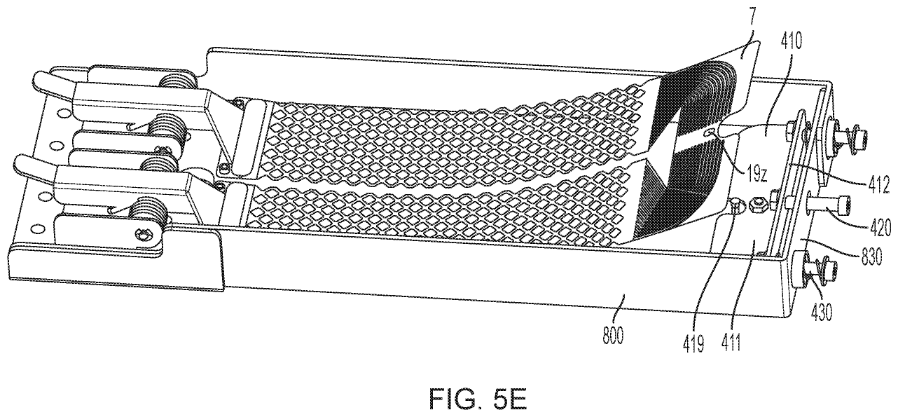

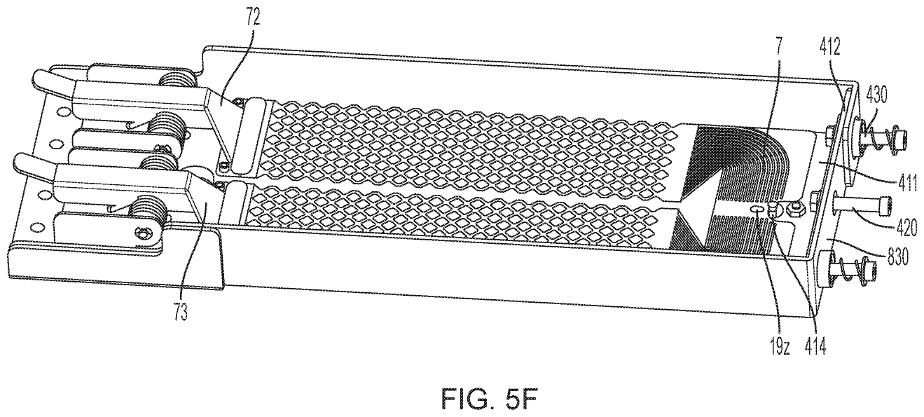

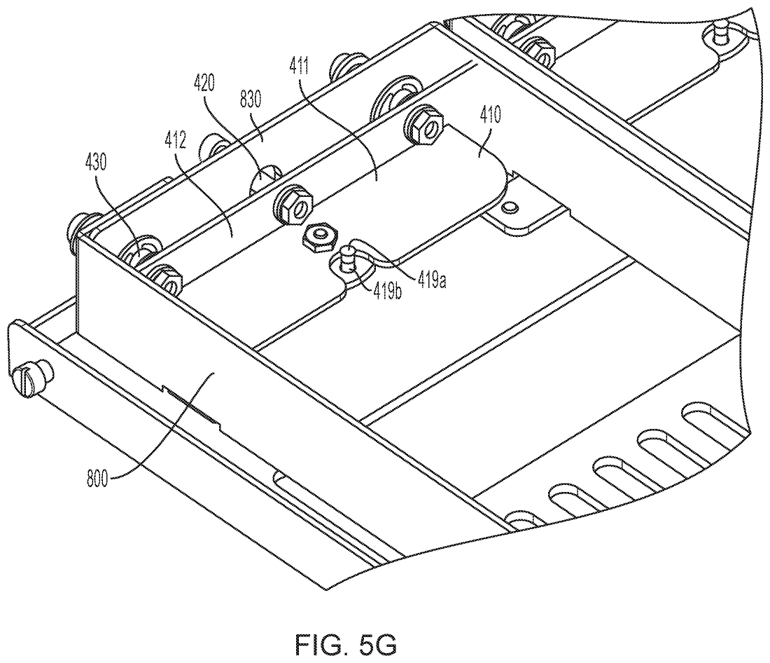

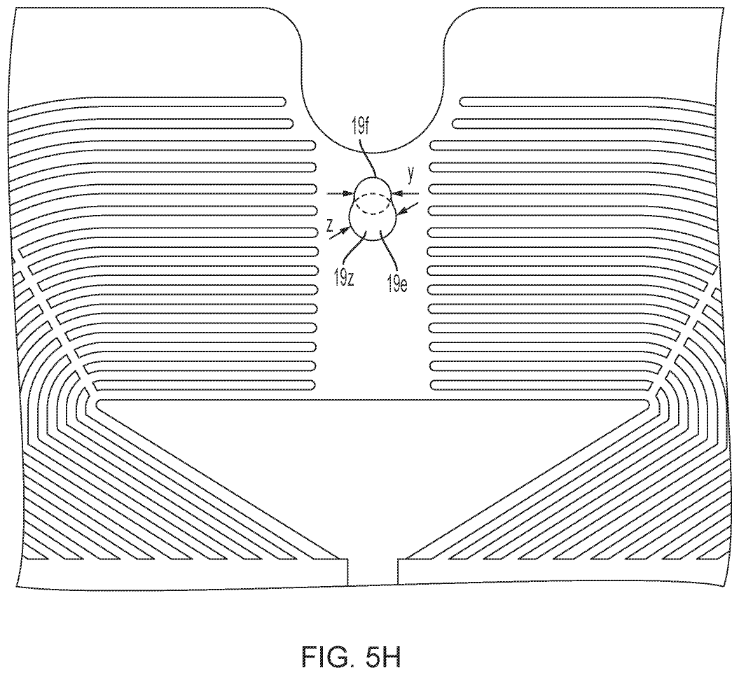

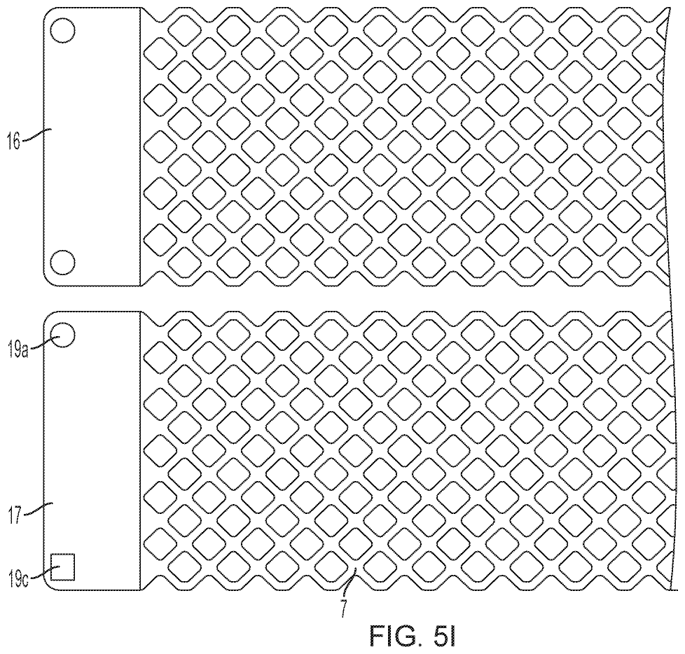

FIG. 5 illustrates a holding box 800 for element 1 and 30 with springs 71 attached to the mated union ends 7 and 8 through holes 19. Secondary conductor bars (as further described in co-pending provisional application “Stepped Heater Element for Use in A High Speed Oven”) 72 and 73 carry a voltage potential that passes electrical current through the two “legs” 74 and 75 of area 3 and 5 of element 1 and 30 through ends 16 and 17. The electrical current may be of various forms, including dc or ac, stepped, triangular, square waves, pulse modulated, or in multiple phases. The holding box which may become part of an oven further including a reflective surface 80 and side walls 81. Monitoring the temperature of said surface or surfaces 80 may be done when they are formed into an oven cavity which may itself be monitored. A predetermined cycle or continuously adjusted cycling based on input to the control system from a sensor and operation of the element may be performed to control the output wavelengths of the heater to optimize performance in an application such as cooking, baking, searing, curing, or other heating. The heater may also be submerged in liquids for heating.

In order to place element 1 within in holder box 800 so as to secure a simultaneous electrical voltage application and a mechanical tensioning, the element ends 302 and 301 are placed under secondary conductor bars (or clamps) 73 and 72 respectively. The secondary conductor bars 73, 72 may be biased to a position where they engage the element ends 16, 17 when provided therein, and when not provided the clamps 73, 72 engage a horizontal surface of the holding box 800. Clamps 73, 72 may be each further connected to the positive and negative electrical circuit that powers the element 1. These clamps 73, 72 may have a positive actuation locking mechanism, a spring forcing mechanism, or any other mechanism intended to provide positive connection and pressure to insure a proper electrical connection. Engagement portions of the clamps 73 and 72 may be nickel plated so as to prevent wear and insure a strong electrical contact with minimal resistance. In some embodiments, each of clamps 73, 72 include a peg that is configured to extend within the corresponding tensioning hole that is provided at the respective end 16, 17 of the element to result in mechanical and electrical connection between the clamps 73, 72 and the element 1.

In an embodiment depicted in FIGS. 5a-5c, a horizontal surface 810 of the holding box 800 may include alignment pegs 819a that extend upwardly therefrom, which are positioned to allow corresponding holes 19a upon ends of the element to receive the alignment pegs 819a. In some embodiments each of the ends 16, 17 may include a single hole 19a, while in other embodiments, each end 16, 17 includes two or more holes 19a. The clamps 73, 72 are biased (such as with springs 311 as depicted in FIG. 5b) to contact a surface of the respective end 16, 17 of the element 1 that is aligned with respective clamp 73, 72 (such as regions 1031 and 1032 depicted in FIG. 5c) and the clamps 73, 72 are biased to contact and compress the respective end 16, 17 upon the horizontal surface 810 of the holding box 800 to mechanically fix the ends 16, 17 to the holding box. As with the embodiment discussed above, the clamps are connected to the positive and negative electrical circuit that powers the element 1. In some embodiments, the clamps 73, 72 may include operators 73a, 72a that allow for user to operate to lift the respective clamp 73, 72 away from contact with the aligned end 16, 17 to allow an element to be removed, and similarly to lift the clamp 73, 72 away from the horizontal surface 810 to allow an element to be attached (via the alignment pegs 819a). FIG. 5b depicts clamp 73 lifted away from contact with the end 16 of the element by the user pressing upon the operator 73a and clamp 72 in contact with end 17 of the element 1.

In another embodiment depicted in FIGS. 5d-5f (with may be used with the embodiment of FIGS. 5a-5c or another embodiment to secure the opposite end of the element 1), folded ends 7, 8 of the element 1 may be received within the holding box 800 with a spring loaded connection. The folded ends 7, 8 of the element 1 may include hole 19z (as in the figures) or a plurality of holes such as holes 19w depicted in FIG. 5c that receive a peg 419 (or pegs for multiple holes) that extends from a carrier 410 that slides along the holding box 800. The carrier 410 may include a horizontal surface 411 from which the peg 419 extends and a biasing surface 412, which may extend perpendicularly upward from the horizontal surface such that is parallel to a side wall 830 of the holding box 800. The biasing surface 412, and therefore the entire carrier 410 is biased toward the side wall 830 with one or more springs 431 that are supported by shafts 430. An operator 420 may be connected to the biasing surface 412 and be capable of being manipulated by the user to slide the carrier 410 against the biasing force of the springs 431. In FIG. 5e, the user has pressed the operator 420 such that the carrier 410 is slid away from the side wall 830 and the user has bent the element 1 to allow for establishing alignment between the hole 19z and the peg 419. In FIG. 5f, the carrier is shown in the normal position with the peg 419 not extending within the hole. In FIG. 5d the peg 419 extends within the hole 19z. As can be understood by one of ordinary skill in the art with a review and understanding of this disclosure, the springs 431 maintain a tension on the element 1 (with the opposite side of the element disposed upon their respective pegs 819 and engaged with the clamps 73, 72) as the size of the element 1 changes as the element is heated and cooled during use, when the element 1 heats up and expands the springs 431 urge the biasing surface 412 and therefore the carrier 410 closer to the side wall 830 and as the element cools down and therefore contracts the springs 431 are pulled to allow the biasing surface 412 and therefore the carrier 410 further from the side wall 830.

In some embodiments, the hole 19z may be a round hole, while in other embodiments, as best shown in FIGS. 5g and 5h, the hole 19z may be a teardrop or keyhole shape, with a first portion 19e that includes a first diameter Z that is larger (such as 20-50% larger) than a diameter (such as a largest diameter as discussed below) of the peg 419 and a second portion 19f with a diameter Y that is smaller than a diameter of the peg 419. The term diameter as used herein may apply to portions of the hole that include a curvature that is greater than half of a circle as well as to the curvature that if completed in a full circle, or greater than half of a circle would form a diameter. In some embodiments, the diameter of the peg 419 at the top end 419a may be larger than the second diameter Y with the peg including a lower portion 419y (below the top end) that has a diameter that is less than the second diameter Y such that the lower portion 419y of the peg extends through the second portion 19f of the hole 19z with the second diameter Y when the element is disposed upon the peg 419, while when in this configuration the element 1 cannot be lifted above the peg 419 due to interference between the second portion 19f of the hole and the top portion 419a of the peg. The first diameter Z of the hole 19z is provided to provide for play between the peg 419 and the hole 19z to allow the peg to be easily inserted within the hole 19z by the user.

In some embodiments, the end 7 of the element may include two or more holes 19w, which may be round holes or shaped as in the hole depicted in FIG. 5g and described above.

In some embodiments, the pegs 819a and the respective holes 19a that engage the pegs 819a may be provided to ensure that the element 1 can only fit onto the pegs 819a in one specific orientation, such as to avoid installing the element 1 upside down or backwards. For example, as depicted in FIG. 5i, in some embodiments, one of the two holes 19c upon the element may be may be square, triangular, or another geometric or arbitrary shape, or round with a different diameter than the other hole 19a, with a correspondingly shaped peg 819a disposed upon the frame 900. The other hole 19a/peg 819a disposed upon the same side of the element may be round or a different shape. Accordingly, the user can only install the element in one orientation and have the holes 19a/19c fit around the pegs 819a disposed upon the holder box 800.

The embodiments described above and depicted in FIGS. 5a-5f are specifically depicted with respect to a folded element 1 that is described within this patent application, one of ordinary skill in the art will readily comprehend with a thorough review of this specification and figures that the embodiments of FIGS. 5a-5f can be readily used for a single layer element or elements with more than two layers, and also for an element with only a single leg (thereby only needing one clamp 73) or with more than two legs (thereby needing the same number of clamps as legs).

One of the observations made of the novel bi-element is the reduction of the magnetic field in areas 300, 400, 301, and 302 in direction 401. In one trial, a single layer region was used for the union area 7 testing in the holding fixture 800 of FIG. 5 and it was found that the magnetic field at 300 and 400 in direction 401 was reduced from about 39 gauss to 9.5 gauss (at 0.1 meters).

While it is difficult to fully characterize the eddy currents induced in the multiple layer heating element, the change of the magnetic field versus a single element and the presumed associated redirection of the electrical current can be considered a significant factor for the increased life.

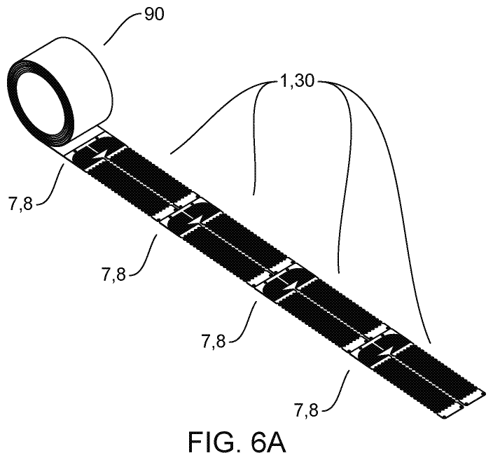

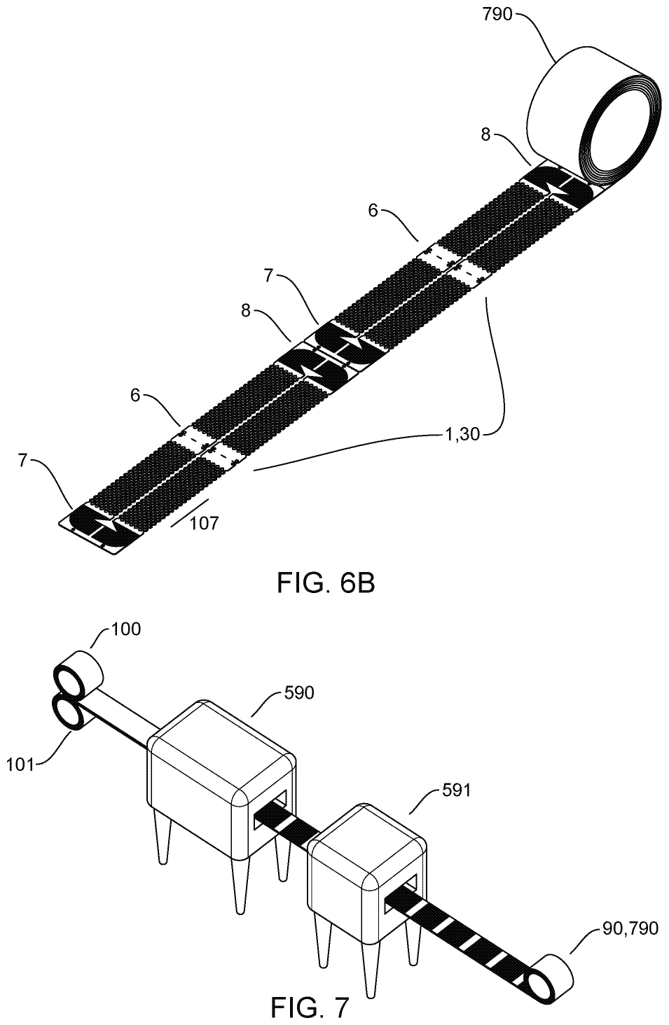

FIG. 6a illustrates a continuous roll 90 of elements 1 and 30 joined sequentially to form a roll with the potential of being operated many millions of cycles. US patent application U.S. Ser. No. 15/183,967 describes a continuous mesh system yet does not describe integrated primary and secondary conductor bars. Co-pending provisional application “Stepped Heater Element for Use in A High Speed Oven” describes primary conductors that are integrated within the continuous mesh yet does not include the two or more layers that form the primary mesh or a post folding process to create a bi-element as herein described per this invention. FIG. 6b is an alternative roll form being a single layer having elements 1 and 30 of FIGS. 1 through 5 formed sequentially but then folded manually or in an automated fashion at the time of use.

The process of manufacturing a roll 90 such as that in FIGS. 6a and 6b is further shown in FIG. 7. The process for making the two halves of element 1 and 30 through etching, stamping, pressing or thinning, or other machine process from blank roll stocks 100 and 101 is done within system or systems 590 and secondary process such as coating done at 591. A single roll 100 may also be used and rather than folding the element 1 per FIGS. 1, 2, and 3, two parallel single sheets may be formed along edge 107 of FIG. 3 and then folded along the edge to create element 30. Other symmetrical folding or manufacturing processes may be employed to create an element with multiple layers per the specifications of this patent and further each of these elements may be parted singularly or in multiples before, during, or after use.

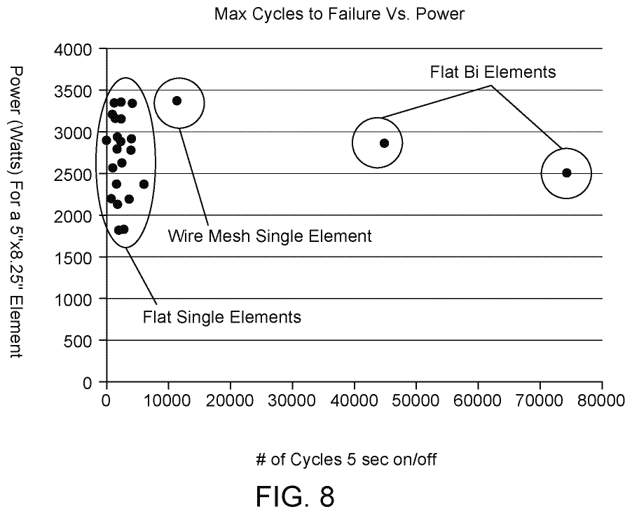

FIG. 8 is a diagram illustrating the relative placement of the multi-planar heating element on a plot of the life during cycling versus the wattage and further compared to past developed heating elements with DER values less than 2 for use in high speed ovens. As can be noted from the graph, the multi-planar elements provide very significant benefit.

The examples presented herein are intended to illustrate potential and specific implementations. It can be appreciated that the examples are intended primarily for purposes of illustration for those skilled in the art. The diagrams depicted herein are provided by way of example. There can be variations to these diagrams or the operations described herein without departing from the spirit of the invention. For instance, in certain cases, method steps or operations can be performed in differing order, or operations can be added, deleted or modified.

1-24. (canceled)

25. A high-speed oven comprising:
a holder box that is configured to receive a removable heating element, wherein the heating element is configured to rapidly heat upon receipt of electrical current therethrough, the heating element being planar and extending from a first end portion to a second end portion,
the holder box includes a first end portion that is configured to removably receive the first end portion of the heating element and a second end portion that is configured to removably receive the second end portion of the heating element,
the holder box supports a clamp that is pivotably mounted upon a horizontal surface of a heater box, the clamp biased toward a position where a first end of the clamp contacts the horizontal surface of the heater box, and pivotable to a second position where the first end is spaced away from the horizontal surface of the heater box,
the horizontal surface comprises a first peg that extends upwardly from the horizontal surface and is disposed proximate to a location where the clamp contacts the horizontal surface of the heater box,
the holder box further comprises a carrier that is slidably mounted thereon and proximate to a second end of the holder box remote from a first end that supports the clamp, the carrier is biased toward a wall of the holder box defining the second end of the holder box and can be urged to slide away from wall and toward the clamp, the carrier supports a second peg thereon.

26. The high-speed oven of claim 25, further comprising a heating element that extends between first and second ends with a central portion therebetween, wherein the heating element comprises a first hole that can be received upon the first peg and a second hole that can be received upon the second peg such that the central portion extends between the first and second end portions of the holder box.

27. The high-speed oven of claim 26, wherein the heating element comprises two or more sheets of metal overlaid upon each other, wherein the first hole extends concentrically through all of the overlaid two or more sheets and the second hole extends concentrically through all of the overlaid two or more sheets.

28. The high-speed oven of claim 25, wherein the first peg is a plurality of first pegs that are spaced apart along the horizontal surface of the holder box and are positioned to each extend within corresponding first holes through the heating element, wherein at least one of the plurality of first pegs is formed with a different cross-sectional geometry than others of the first pegs, wherein a corresponding at least one of the first holes is formed with a cross-sectional geometry that is the same as the at least one of the plurality of first pegs with a different cross-sectional geometry.

29. The high-speed oven of claim 25, wherein the second peg comprises a top portion with a cross-sectional geometry that is larger than a second portion below the top portion, wherein the heating element comprises a second hole that can received upon the second peg, wherein the second hole includes a first portion with a diameter that is larger than a largest diameter of the top portion of the second peg, and a second portion with a diameter that is smaller than the largest diameter of the top portion but is larger than a diameter of the second portion of the second peg.

30. The high-speed oven of claim 26, wherein the heating element further comprises first and second fingers that are spaced apart from each other and both extend from the second end of the heating element, wherein the second end of the heating element provides an electrical connection between the first and second fingers, and wherein the first end of the heating element include a first end of the first finger and a first end of the second finger, wherein the first hole comprises a hole disposed upon the first end of the first finger and a hole disposed upon the first end of the second finger, wherein the first peg comprises two or more pegs disposed upon the horizontal surface that are aligned with the holes upon the first ends of the first and second fingers when the heating element is aligned upon holder box.

31. The high-speed oven of claim 30, wherein the clamp is first and second clamps disposed proximate to each other upon the horizontal surface, wherein the first clamp is arranged to make electrical contact with the first end of the first finger and the second clamp is arranged to independently make electrical contact with the first end of the second finger, wherein the first and second clamps are wired to make opposite electrical contact with the first and second fingers of the heating element.

32. The high-speed oven of claim 31, wherein the first clamp is arranged to make positive electrical contact with the first end of the first finger and the second clamp is arranged to make negative electrical contact with the first end of the second finger, wherein the electrical current flowing through the first and second clamps and the heating electrode is AC or DC current.

33. The high-speed oven of claim 25, wherein the carrier includes an operator that allows a user to urge the carrier away from the wall and toward the clamp.

34. The high-speed oven of claim 25, wherein the holder box is configured to allow the heating element to be installed and removed therefrom without any tools.

35. The high-speed oven of claim 25, wherein when a heating element extends between the first and second end portions of the holder box and is connected to the first and second pegs, the carrier slides with respect to the holder box when the heating element expands or contracts due to a change in temperature of the heating element, which maintains the heating element in tension within the holder box.

36. The high-speed oven of claim 27, wherein the two or more sheets of metal comprise a mesh or lattice structure along the central portion of the heating element.

37. The high-speed oven of claim 27, wherein the two or more sheets comprise at least two different thicknesses.

38. The high-speed oven of claim 27, wherein each of the two or more sheets comprise a planar section, and a thickness of each of the planar sections is greater than 0.001 inches.
